(19) United States
(12) Patent Application Publication
(10) Pub. No.: US 2023/0347263 A1
(43) Pub. Date: Nov. 2, 2023

(54) Oil Vacuum Stabilizer

(71) Applicant: Bell Engineering, Inc., Beaumont, TX (US)

(72) Inventor: Robert Richardson, Beaumont, TX (US)

(73) Assignee: Bell Engineering, Inc., Beaumont, TX (US)

(21) Appl. No.: 18/063,673

(22) Filed: Dec. 8, 2022

Related U.S. Application Data
(60) Provisional application No. 63/336,135, filed on Apr. 28, 2022.

(51) Int. Cl. B01D 17/02; E21B 43/34

(52) U.S. Cl. CPC B01D 17/02; E21B 43/34

(57) ABSTRACT

A method and apparatus for removing volatiles and basic sediments and water from oil for delivery to a pipeline or storage.

### RELATED APPLICATIONS

This application claims priority to U.S. Provisional Application No. 63/336,135, filed Apr. 28, 2022.

### BACKGROUND OF THE INVENTION

### Field of Invention

The present disclosure relates to a process and related apparatuses to condition non-stabilized produced crude oil for meeting requirements to ensure safe processing, transport, and/or storage.

### Background

Crude oil, such as that produced from tight shale plays, can contain abundant amounts of volatile light organic compounds such as methane, ethane, propane, and butanes and other light organic compounds in solution. The presence of these volatile compounds, in a large enough amount, can cause an unstable increase in the vapor pressure of the liquid creating a risk of off-gassing, overpressure, explosion, pump cavitation, etc. while the crude oil is stored or/and or transported. The vapor pressure of crude oil is commonly measured in PSIA as Reid Vapor Pressure (RVP). Several companies and governmental bodies within the United States of America are setting limits on acceptable levels of RVP within pipelines and rail cars. This is due to several rail car accidents and disasters involving volatile crude oil resulting in loss of life and property. Transport of high RVP crude oil from colder to warmer climates exacerbates the problem, as the crude oil becomes increasingly volatile as temperature increases. High RVP crude oil within pipeline operations can cause pump cavitation, vapor lock, and lower pump efficiencies, impacting operations, as well as increase fugitive emissions at storage facilities. Stringent limits have also been placed on fugitive emissions from oil exploration and production activities by the United Stated Environmental Protection Agency (EPA) set forth in 40 CFR Part 60 Subpart OOOO (Quad-O) penalizing operators for leaks and storage tank off-gassing. Even when hydrocarbon vapors are flared, the public perception of “pollution” can be negative. A common practice to decrease the RVP or volatility of the crude oil to comply with rules and regulations has been to use a heater treater or heated separator. These devices are not an efficient method to stabilize the crude oil and are often required to operate above the temperature design parameters resulting in fire tube coking and failure. Volatile crude oil stored in atmospheric storage tanks causes off-gassing within the storage vessels increasing the likelihood fugitive emissions, fire, and/or explosions.

### SUMMARY OF EXAMPLE EMBODIMENTS

An example embodiment may include an apparatus for separating production fluids including a first tank for separating vapor from a first liquid hydrocarbons input with a first gas output, a first fluid output, and a second fluid output, a first pump for generating a first pressurized fluid collected from the first fluid output of the first tank, a second tank for separating vapor from the second fluid output and having a third fluid output and a second gas output, a first eductor using the first pressurized fluid to draw a vacuum on the second gas output of the second tank, wherein the first eductor output pressurizes the first tank, a third tank containing vapor and having a third gas output and a fourth gas output, a second pump for removing the third fluid output from the second tank to form a first oil output, a third pump for removing low pressure vapor from the third gas output of the third tank and pressurizing it into a first pressurized vapor, and a second eductor using the first pressurized vapor to draw a vacuum on the first gas output of the first tank.

A variation of the example embodiment may include using a portion of the first oil output to maintain the fluid level in the second tank. At least one of the first pump, second pump, or third pump may be an electrically driven pump. The first eductor may pressurize the first tank to between 0-5 psig. The first tank may have a basic sediments and water output. The second tank may have a basic sediments and water output. The first eductor may generate a pressurized liquid and vapor output for pressurizing the first tank. It may use a first back pressure control valve to moderate the vapor drawn from the first tank. It may use a liquid control valve to moderate a liquid hydrocarbon stream from the first tank to the second tank. The first oil output may be at less than 9 psia Reid pressure and between 20-100 psig.

An example embodiment may include a method for separating liquid and vapor hydrocarbons including collecting a first mixture of liquid and vapor hydrocarbons in a first tank, pressurizing a first tank using a first pump and first eductor, wherein the first pump generates a first pressurized fluid by drawing a first fluid from the first tank and pumping it into the first eductor to generate a vacuum on a second tank and providing a second pressurized mixture of 5 liquid and vapor hydrocarbons into the first tank, pressurizing a second tank using a second pump, wherein the second pump generates a second pressurized fluid by drawing a second fluid from the first tank and pumping a first portion of the second pressurized fluid into the second tank, pressurizing a third tank using a third pump, wherein the third pump generates a first pressurized vapor by drawing a first vapor from the third tank and pumping into a second eductor, drawing a vacuum on the first tank and generating a second pressurized vapor used to pressurize the third tank to a desired pressured.

A variation of the example embodiment may include the second portion of the second pressurized fluid being a first oil output. It may maintain a desired first fluid level in the first tank. It may maintain a desired second fluid level in the second tank. It may remove basic sediments and water from the first tank. It may remove basic sediments and water from the second tank. It may maintain a desired pressure in the first tank.

An example embodiment may include a method for lowering vapors in a hydrocarbon stream including collecting a hydrocarbon fluid, with a first Reid vapor pressure, in a first tank, pumping a portion of the hydrocarbon fluid into a second tank, drawing a first vacuum on the second tank to remove a first vapor stream, pumping the first vapor stream into the first tank, drawing a second vacuum on the first tank to remove a second vapor stream, and pumping a portion of the hydrocarbon fluid from the second tank to produce a first fluid output having a lower Reid vapor pressure than the hydrocarbon fluid collected in the first tank.

A variation of the example embodiment may include separating a portion of the hydrocarbon fluid in the second tank into a third tank, drawing a third vacuum on the third tank to remove a third vapor stream, and pumping the third vapor stream into the second tank. It may include pumping the second vapor stream into a vapor collection tank. It may include pumping the second vapor stream into a vapor collection tank. It may include drawing the first vacuum on the second tank using pressurized fluid pumped from the first tank. Drawing the third vacuum on the third tank may use pressurized fluid pumped from the second tank. Drawing the second vacuum on the first tank may use pressurized vapor pumped through an eductor. It may separate basic sediments and water from the first tank. It may separate basic sediments and water from the second tank. The second tank may be a plurality of tanks. The pumping may use an electrical pump.

### BRIEF DESCRIPTION OF THE DRAWINGS

For a thorough understanding of the present invention, reference is made to the following detailed description of the preferred embodiments, taken in conjunction with the accompanying drawings in which reference numbers designate like or similar elements throughout the several figures of the drawing. Briefly:

FIG. 1 depicts an example embodiment of vacuum liquid vapor separator.

FIG. 2 depicts an example embodiment of vacuum liquid vapor separator.

FIG. 3 depicts an example embodiment of vacuum liquid vapor separator.

FIG. 4 depicts an example embodiment of vacuum liquid vapor separator.

### DETAILED DESCRIPTION OF EXAMPLES OF THE INVENTION

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems, and method steps. It is to be expected that various equivalents, alternatives, and modifications are possible within the scope of the appended claims.

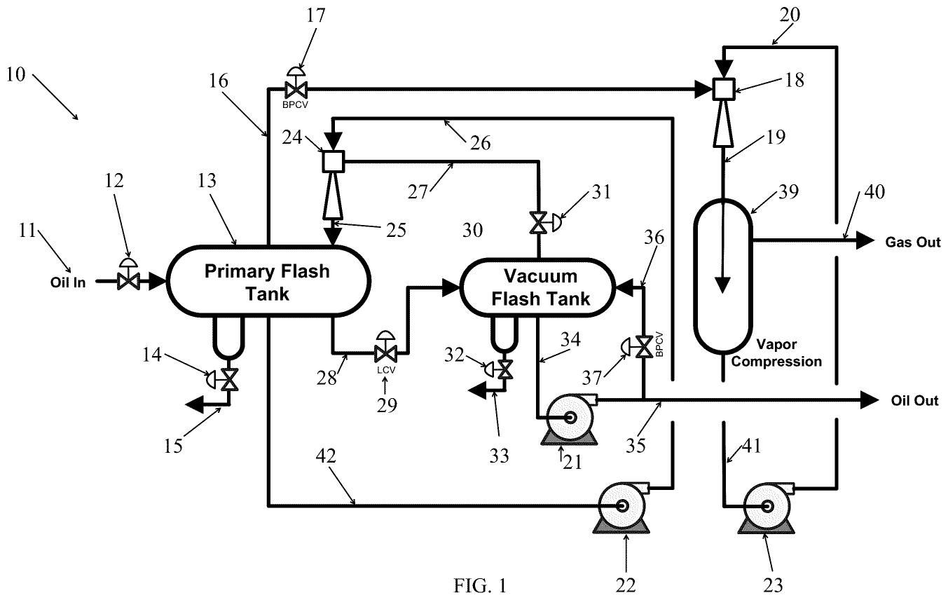

An example embodiment is disclosed in FIG. 1 showing an oil vacuum stabilizer system 10. Oil 11 is received and regulated by valve 12 as it enters primary flash tank 13. Oil 11 has a first Reid vapor pressure. Basic sediments and water (BSW) 15 is separates out via valve 14. Vapor 16 leaves the primary flash tank 13 and is regulated by back pressure control valve 17. The vapor 16 is drawn by a vacuum created by eductor 18. An eductor uses the Bernoulli principle to draw a vacuum on a first fluid or gas by passing a second fluid or gas at a higher pressure through an orifice or restriction, resulting in a output that is a mixture of the first and second fluid or gas. Eductor 18 uses a liquid 20 pressurized by pump 23, such as produced oil or produced water, to pull a vacuum on vapor 16 and then output high pressure vapor 19 into vapor compression tank 39. Gas 40 leaves the vapor compression tank 39.

Pump 22 pumps oil from the primary flash tank 13 and returns it to the primary flash tank under pressure. It takes fluid 42 and pressurizes it into fluid 26 for use in the eductor 24, which uses the high-pressure fluid 26 to pull a vacuum on gas 27 that exits the vacuum flash tank 30 and is regulated by valve 31. Educator 24 has an oil and gas mixture output 25 that pressurizes the primary flash tank 13. Oil 28 is supplied from the primary flash tank 13 to the vacuum flash tank 30 via the level control valve 29, which maintains a desired oil liquid level inside the primary flash tank 13. BSW 33 is removed from the vacuum flash tank 30 via valve 32. Oil 34 is pulled from the vacuum flash tank 30 via pump 21 and the pressurized oil 35 is sent to the pipeline or storage. Pressurized oil 35 has a second Reid vapor pressure that is lower than the first Reid vapor pressure of oil 11. A portion 36 of the pressurized oil 35 is sent back to the vacuum flash tank via a back pressure control valve 37.

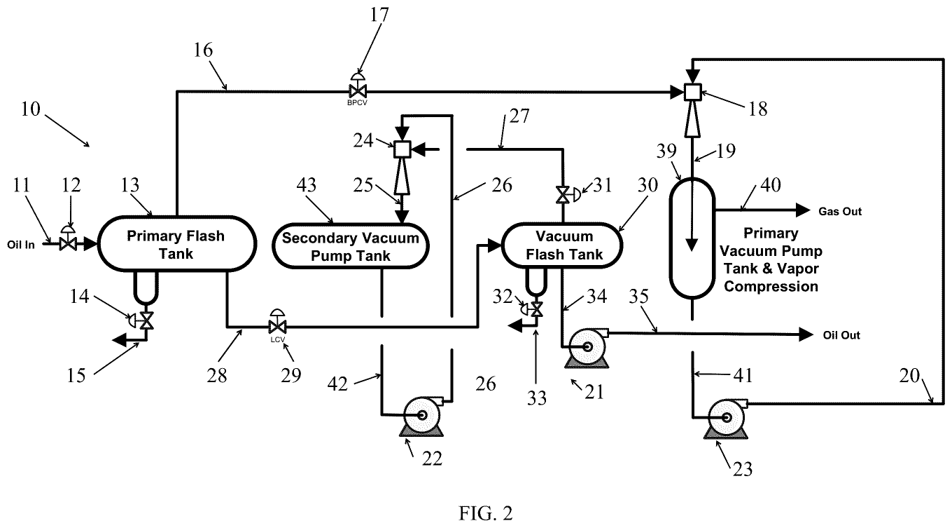

An example embodiment is disclosed in FIG. 2 showing an oil vacuum stabilizer system 10. Oil 11 is received and regulated by valve 12 as it enters primary flash tank 13. Oil 11 has a first Reid vapor pressure. Basic sediments and water (BSW) 15 separate out via valve 14. Vapor 16 leaves the primary flash tank 13 and is regulated by back pressure control valve 17. The vapor 16 is drawn by a vacuum created by eductor 18. Eductor 18 uses a liquid 20 pressurized by pump 23, such as produced oil or produced water, to pull a vacuum on vapor 16 and then output high pressure vapor 19 into vapor compression tank 39. Gas 40 leaves the vapor compression tank 39.

Still referring to FIG. 2, pump 22 pumps a fluid 42 from the secondary vacuum pump tank 43 and pressurizes it into fluid 26 for use in the eductor 24, which uses the high-pressure fluid 26 to pull a vacuum on gas 27 that exits the vacuum flash tank 30 and is regulated by valve 31. Educator 24 has an oil and gas mixture output 25 that pressurizes the primary flash tank 13. Oil 28 is supplied from the primary flash tank 13 to the vacuum flash tank 30 via the level control valve 29, which maintains a desired oil liquid level inside the primary flash tank 13. BSW 33 is removed from the vacuum flash tank 30 via valve 32. Oil 34 is pulled from the vacuum flash tank 30 via pump 21 and the pressurized oil 35 is sent to the pipeline or storage. Pressurized oil 35 has a second Reid vapor pressure that is lower than the first Reid vapor pressure of oil 11.

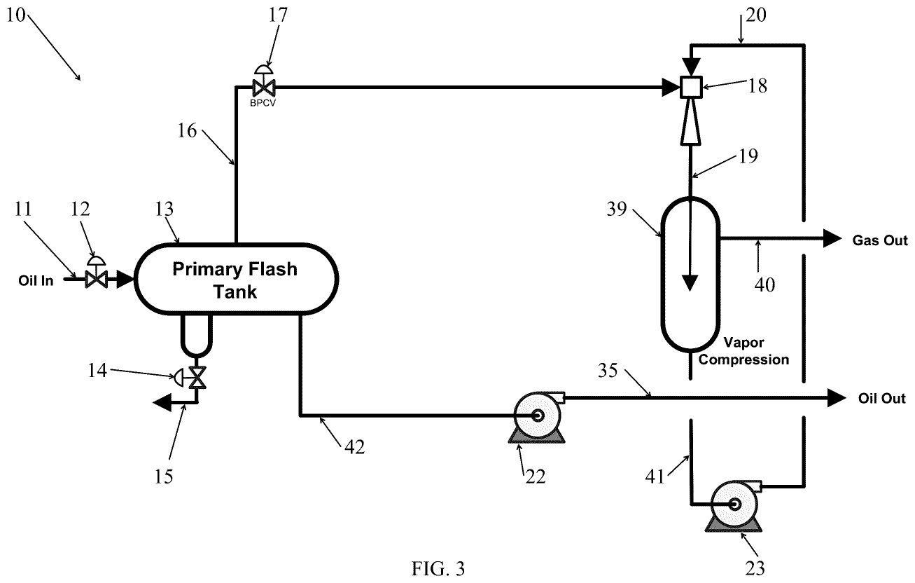

An example embodiment is disclosed in FIG. 3 showing an oil vacuum stabilizer system 10. Oil 11 is received and regulated by valve 12 as it enters primary flash tank 13. Oil 11 has a first Reid vapor pressure. Basic sediments and water (BSW) 15 separate out via valve 14. Vapor 16 leaves the primary flash tank 13 and is regulated by back pressure control valve 17. The vapor 16 is drawn by a vacuum created by eductor 18. Eductor 18 uses a liquid 20 pressurized by pump 23, such as produced oil or produced water, to pull a vacuum on vapor 16 and then output high pressure vapor 19 into vapor compression tank 39. Gas 40 leaves the vapor compression tank 39. Pump 22 pumps a fluid 42 from the secondary vacuum pump tank 43 and pressurizes it into fluid 35. The pressurized oil 35 is sent to the pipeline or storage. Pressurized oil 35 has a second Reid vapor pressure that is lower than the first Reid vapor pressure of oil 11.

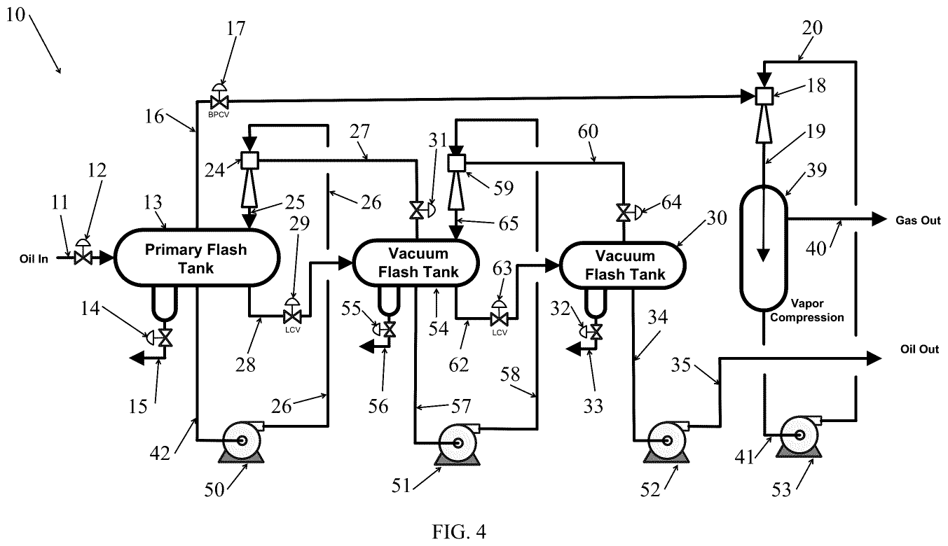

An example embodiment is disclosed in FIG. 4 showing an oil vacuum stabilizer system 10. Oil 11 is received and regulated by valve 12 as it enters primary flash tank 13. Oil 11 has a first Reid vapor pressure. Basic sediments and water (BSW) 15 separated out via valve 14. Vapor 16 leaves the primary flash tank 13 and is regulated by back pressure control valve 17. The vapor 16 is drawn by a vacuum created by eductor 18. Eductor 18 uses a liquid 20 pressurized by pump 53, such as produced oil or produced water, to pull a vacuum on vapor 16 and then output high pressure vapor 19 into vapor compression tank 39. Gas 40 leaves the vapor compression tank 39.

Still referring to FIG. 4, pump 50 pumps a fluid 42 from the primary flash tank 43 and pressurizes it into fluid 26 for use in the eductor 24, which uses the high-pressure fluid 26 to pull a vacuum on gas 27 that exits the vacuum flash tank 54 and is regulated by valve 31. Educator 24 has an oil and gas mixture output 25 that pressurizes the primary flash tank 13. Oil 28 is supplied from the primary flash tank 13 to the vacuum flash tank 54 via the level control valve 29, which maintains a desired oil liquid level inside the primary flash tank 13. BSW 56 is removed from the vacuum flash tank 54 via valve 55.

Oil 62 exits the vacuum flash tank 54 controlled by level control valve 63 and enters vacuum flash tank 30.

Pump 51 pumps a fluid 57 from the vacuum flash tank 54 and pressurizes it into fluid 58 for use in the eductor 59, which uses the high-pressure fluid 58 to pull a vacuum on gas 60 that exits the vacuum flash tank 30 and is regulated by valve 64. High pressure fluid/gas mixture 65 is then sent to vacuum flash tank 54.

Oil 62 is supplied from the vacuum flash tank 54 to the vacuum flash tank 30 via the level control valve 63, which maintains a desired oil liquid level inside the vacuum flash tank 54. BSW 33 is removed from the vacuum flash tank 30 via valve 32. Oil 34 is pulled from the vacuum flash tank 30 via pump 52 and the pressurized oil 35 is sent to the pipeline or storage. Pressurized oil 35 has a second Reid vapor pressure that is lower than the first Reid vapor pressure of oil 11.

An example gas output 40 may be in the pressure range of 20-100 psig. An example oil output 35 may be less than 9 psia Reid Vapor Pressure (RVP) and between 20-100 psig.

The disclosed embodiments oil and gas mixture output 25 may have the pressure of the 0-5 psig.

The disclosed embodiments provide a function of lowering revapor and lowering BSW levels while providing oil to pipelines or storage at or below 9 psia. The use of inductors eliminates the need for compressors and the pumps disclosed herein may be electric pumps.

For purposes of understanding the drawings, PIT means “pressure indicator/transmitter.” LIT means “level indicator/transmitter.” PI means “pressure indicator.” DPIC means “differential pressure indicator control.” LC means “level control.” TIT means “temperature indicator transmitter.” FIT means “flow indicator/transmitter.” AT mean “auxiliary transmitter,” which may include a capacitance water cut meter.

Although the invention has been described in terms of embodiments which are set forth in detail, it should be understood that this is by illustration only and that the invention is not necessarily limited thereto. The alternative embodiments and operating techniques will become apparent to those of ordinary skill in the art in view of the present disclosure. Accordingly, modifications of the invention are contemplated which may be made without departing from the spirit of the claimed invention.

1. An apparatus for separating production fluids comprising:
a first tank for separating vapor from a first liquid hydrocarbons input with a first gas output, a first fluid output, and a second fluid output;
a first pump for generating a first pressurized fluid collected from the first fluid output of the first tank;
a second tank for separating vapor from the second fluid output and having a third fluid output and a second gas output;
a first eductor using the first pressurized fluid to draw a vacuum on the second gas output of the second tank, wherein the first eductor output pressurizes the first tank;
a third tank containing vapor and having a third gas output and a fourth gas output;
a second pump for removing the third fluid output from the second tank to form a first oil output;
a third pump for removing low pressure vapor from the third gas output of the third tank and pressurizing it into a first pressurized vapor; and
a second eductor using the first pressurized vapor to draw a vacuum on the first gas output of the first tank.

2. The apparatus for separating production fluids of claim 1 further comprising, using a portion of the first oil output to maintain the fluid level in the second tank.

3. The apparatus for separating production fluids of claim 1 further wherein at least one of the first pump, second pump, or third pump is an electrically driven pump.

4. The apparatus for separating production fluids of claim 1 further wherein the first eductor pressurized the first tank to between 0-5 psig.

5. The apparatus for separating production fluids of claim 1 further comprising, the first tank having a basic sediments and water output.

6. The apparatus for separating production fluids of claim 1 further comprising, the second tank having a basic sediments and water output.

7. The apparatus for separating production fluids of claim 1 further comprising, the first eductor generating a pressurized liquid and vapor output for pressurizing the first tank.

8. The apparatus for separating production fluids of claim 1 further comprising, using a first back pressure control valve to moderate the vapor drawn from the first tank.

9. The apparatus for separating production fluids of claim 1 further comprising, using a liquid control valve to moderate a liquid hydrocarbon stream from the first tank to the second tank.

10. The apparatus for separating production fluids of claim 1 wherein the first oil output is at less than 9 psia Reid pressure and between 20-100 psig.

11. A method for separating liquid and vapor hydrocarbons comprising:
collecting a first mixture of liquid and vapor hydrocarbons in a first tank;
pressurizing a first tank using a first pump and first eductor, wherein the first pump generates a first pressurized fluid by drawing a first fluid from the first tank and pumping it into the first eductor to generate a vacuum on a second tank and providing a second pressurized mixture of liquid and vapor hydrocarbons into the first tank;
pressurizing a second tank using a second pump, wherein the second pump generates a second pressurized fluid by drawing a second fluid from the first tank and pumping a first portion of the second pressurized fluid into the second tank;
pressurizing a third tank using a third pump, wherein the third pump generates a first pressurized vapor by drawing a first vapor from the third tank and pumping into a second eductor, drawing a vacuum on the first tank and generating a second pressurized vapor used to pressurize the third tank to a desired pressured.

12. The method for separating liquid and vapor hydrocarbons of claim 11, wherein a second portion of the second pressurized fluid is a first oil output.

13. The method for separating liquid and vapor hydrocarbons of claim 11, further comprising maintaining a desired first fluid level in the first tank.

14. The method for separating liquid and vapor hydrocarbons of claim 11, further comprising maintaining a desired second fluid level in the second tank.

15. The method for separating liquid and vapor hydrocarbons of claim 11, further comprising removing basic sediments and water from the first tank.

16. The method for separating liquid and vapor hydrocarbons of claim 11, further comprising removing basic sediments and water from the second tank.

17. The method for separating liquid and vapor hydrocarbons of claim 11, further comprising maintaining a desired pressure in the first tank.

18. A method for lowering vapors in a hydrocarbon stream comprising:
collecting a hydrocarbon fluid in a first tank;
pumping a portion of the hydrocarbon fluid into a second tank;
drawing a first vacuum on the second tank to remove a first vapor stream;
pumping the first vapor stream into the first tank;
drawing a second vacuum on the first tank to remove a second vapor stream; and
pumping a portion of the hydrocarbon fluid from the second tank to produce a first fluid output having a lower Reid vapor pressure than the hydrocarbon fluid collected in the first tank.

19. The method for lowering vapors in a hydrocarbon stream of claim 18 further comprising separating a portion of the hydrocarbon fluid in the second tank into a third tank, drawing a third vacuum on the third tank to remove a third vapor stream, and pumping the third vapor stream into the second tank.

20. The method for lowering vapors in a hydrocarbon stream of claim 18 wherein drawing the first vacuum on the second tank uses pressurized fluid pumped from the first tank.

21. The method for lowering vapors in a hydrocarbon stream of claim 18, further comprising maintaining a desired first fluid level in the first tank.

22. The method for lowering vapors in a hydrocarbon stream of claim 18, further comprising maintaining a desired second fluid level in the second tank.

23. The method for lowering vapors in a hydrocarbon stream of claim 18, further comprising removing basic sediments and water from the first tank.

24. The method for lowering vapors in a hydrocarbon stream of claim 18, further comprising removing basic sediments and water from the second tank.

25. The method for lowering vapors in a hydrocarbon stream of claim 18, further comprising maintaining a desired pressure in the first tank.

26. The method for lowering vapors in a hydrocarbon stream of claim 18, further comprising using the portion of the hydrocarbon fluid collected from the first tank to maintain the fluid level in the second tank.

27. The method for lowering vapors in a hydrocarbon stream of claim 18, further comprising pressurizing the first tank to between 0-5 psig.

28. The method for lowering vapors in a hydrocarbon stream of claim 18, further comprising separating basic sediments and water from the first tank.

29. The method for lowering vapors in a hydrocarbon stream of claim 18, further comprising separating basic sediments and water from the second tank.

30. The method for lowering vapors in a hydrocarbon stream of claim 18, further comprising generating a pressurized liquid and vapor output for pressurizing the first tank.

31. The method for lowering vapors in a hydrocarbon stream of claim 18, further comprising using a first back pressure control valve to moderate the vapor drawn from the first tank.

32. The method for lowering vapors in a hydrocarbon stream of claim 18, further comprising using a liquid control valve to moderate a liquid hydrocarbon stream from the first tank to the second tank.

33. The method for lowering vapors in a hydrocarbon stream of claim 18, further comprising maintaining the first fluid output having a 9 psia Reid pressure and between 20-100 psig.
